(19) United States
(12) Patent Application Publication
(10) Pub. No.: US 2013/0047003 A1
(43) Pub. Date: Feb. 21, 2013

(54) Estimating Power Consumption of an Application

(71) Applicants: Markus Koesler, Landshut (DE); Wolfgang Lutsch, Freising Bayern (DE); Volker Rzehak, Ergolding (DE)

(72) Inventors: Markus Koesler, Landshut (DE); Wolfgang Lutsch, Freising Bayern (DE); Volker Rzehak, Ergolding (DE)

(73) Assignee: TEXAS INSTRUMENTS INCORPORATED, Dallas, TX (US)

(21) Appl. No.: 13/473,251

(22) Filed: May 16, 2012

(30) Foreign Application Priority Data
Aug. 17, 2011 (DE) 10 2011 110 366.3

(51) Int. Cl. G06F 1/00

(52) U.S. Cl. 713/300

(57) ABSTRACT

The invention relates to an electronic device, a debug unit and to a method for estimating a power consumption of an application that is executable on an electronic device having a plurality of modules. A status of at least one routine of the application and a status of at least one module of the electronic device is determined. Further a power consumption of the at least one module is estimated by allocating a predetermined power consumption value to the detected status of the respective module. The determined status of the routine may be assigned to the determined status of the at least one module and to the estimated power consumption of the module so as to provide an estimated power consumption of the application.

This application claims priority from German Patent Application No. 10 2011 110 366.3, filed Aug. 17, 2011, which is hereby incorporated by reference for all purposes.

### BACKGROUND

Modern electronic devices like microprocessors comprise a plurality of modules, e.g. embedded processes, digital and/or analog I/O modules, auxiliary modules etc. For battery-powered electronic devices, it is desirable to optimize the operation of the electronic device in an energy-efficient way, such that the battery runtime may be extended. Not only the hardware modules but also the software applications running on the electronic device have to be examined with respect to energy consumption, in order to detect potential areas for improvements. This task requires that the software designer or programmer is enabled to correlate the energy consumption of the electronic device with the execution of the application.

### SUMMARY

It is an object of the invention to provide an improved method, debug unit and electronic device for estimating a power consumption of an application that is executable on an electronic device.

In one aspect of the invention, a method of estimating a power consumption of an application that is executable on an electronic device having a plurality of modules is provided. A status of at least one routine of the application may be determined. The status of all routines or selected routines which are simultaneously executed in the electronic device is determined at a certain point in time. Further, the status of at least one module of the electronic device is determined. The status of all modules or selected modules that are a part of the electronic device is determined. A power consumption of the at least one module may be estimated by allocating a predetermined power consumption value to the detected status of the respective module. The determined status of the routine may be assigned to the determined status of the at least one module and to the estimated power consumption. This assignment may be performed so as to provide an estimated actual power consumption of the application.

The power consumption of the electronic device may be estimated without any external power measurement. No measurement equipment is necessary. This leads to a reduction of costs. Further, the accuracy of the power measurement may be improved because there are no external effects which may influence the operation of the electronic device. The power consumption of the electronic device may be estimated even at high frequencies. Further, the power measurement may be implemented in the application-specific printed circuit board. This simplifies the development process because there is no need for any additional circuitry.

The power consumption of the at least one module is estimated by help of the data sheet of the electronic device. In most of the cases, an individual power measurement for each block of an electronic device is a challenging task. It has been recognized that the data sheet provides a higher accuracy in many cases.

The status of the at least one module may be determined by help of the standard JTAG (Joint Test Action Group) device state register interface. Any other trace port may be suitable, too. This device state register may comprise data indicating a status of the application, e.g. an address. Further, the JTAG device state register may comprise data indicating a status of the at least one module of the electronic device. Based on this status information, the power consumption of a respective module may be estimated. The status data may be output to an external debugging host, e.g. an IDE debugger.

It has been recognized that it is important to spot or localize the power consumption. In other words, it has bee recognized that it is fruitful information to know which routine takes how much power at a certain status of the application. It is rather important to get information where most of the energy is taken than knowing the absolute and exact value of the power consumption. Accordingly, the energy consumption of at least two routines may be estimated. These two values may be set in relation to each other. Of course, this may be performed for more than two routines. This will result in a power statistic comprising information on a relative distribution of the power consumption. Based on this information, the designer may spot the highest energy consumption with a high spatial and a high time resolution. In other words, the developer may know which routine takes most of the energy at a certain status of the application and he or she will know something about a distribution of the energy consumption. The developer is therefore set into the position to optimize the application.

For estimating the power consumption of a routine, a number of clock cycles that are taken by the respective routine may be estimated, according to another aspect of the invention. Even a power statistic may be generated based on this information. A number of necessary CPU clock cycles may be determined for a single routine, a plurality of selected routines and/or for all routines that are a part of the application. It has been recognized that the resulting power statistic in terms of clock cycles is valuable information with respect to the power consumption of the routines at issue. In other words, the power consumption of a routine may be expressed in terms of clock cycles. This is a reasonable approach because nearly all CPU clock cycles need approximately the same power. The programmer gets a first advice for optimization of the application with respect to energy consumption. A reduction of CPU clock cycles that are taken by the respective routine will nearly always lead to significant energy savings.

In another aspect of the invention, a system activity profile is generated. This is performed by determining a status of at least two modules of the electronic device and by outputting this information in a time-dependent plot. The status may be indicative to a power consumption of the module. The developer of the application is provided with information allowing an alignment in time domain between parallel working blocks of the electronic device. For instance, the operation of auxiliary modules like clock generation and power management may be aligned in time domain. The blocks may be active within the same time span. Accordingly, these modules may be switched into a lower power mode as long as possible which will result in energy savings. For analog components or modules it may be advantageous if not required to keep the system noise as low as possible. This may be achieved by disabling all digital parts of the electronic device. By help of the time-dependent plot, the developer may align the operation of e.g. the analogue and digital blocks in such a way that there is no or minimal overlap of the operating times. Options for energy saving measures may be identified by checking the interdependencies of the blocks. The total power consumption of the electronic device may be reduced by eliminating needless operating time of its modules. On the other hand, the activity of several blocks may be aggregated in time domain and thereby their activity may be reduced to a necessary minimum interval.

In another aspect of the invention, a time-dependent power profile of the application may be generated. This may be performed by assigning the determined status of the application to the estimated power consumption of at least one module for a plurality of points in time. The power consumption of the application may be determined by determining the status of the modules that take part in the execution of the application at the respective point in time. The power profile may be output in a time-dependent plot. In comparison to the above-mentioned activity profile, the time-dependent power profile enables the developer to identify the routines of the application that take most of the energy. Accordingly, the developer may optimize the routines with respect to timing. The approach may be focused on the respective modules or routines which are promising the highest amount of power savings.

According to an embodiment, the determination of the status of the at least one routine of the application and/or the determination of the status of the at least one module of the electronic device is performed upon reception of a trigger. Upon reception of the trigger, each module of the electronic device may capture its internal state, i.e. the status that is indicative of the power consumption. This data may be written to the JTAG device state register. The status of the register may be communicated via a debug interface of the electronic device to an external debug unit. Preferably, the captured power status of the modules of the electronic device is fetched in sequence. Additional to the module's power state, upon reception of the trigger, the status of the application may be captured. The captured information may incorporate the actual program counter and CPU status information.

According to an aspect of the invention, one or more modules of the electronic device may be selected for optimization. Accordingly, the power status of these devices only will be captured and delivered via a suitable bus system, e.g. via the JTAG device state register. This may be advantageous because the communication of the status information takes a certain time. This time will be much shorter if a reduced number of modules are selected. Consequently, the method for estimating the power consumption of the electronic device is much faster and has a higher time resolution.

The method according to aspects of the invention provides an estimation of the power consumption having a high resolution in time domain as well as in spatial domain because the power state of each module may be observed. The time resolution is neither limited by the speed of an external power measurement nor is it limited by low pass filtering effects in the power supply lines of the electronic device. The time resolution is only limited by the data communication speed for delivery of power state data to the debugging host. Advantageously, the effort for external hardware is very limited because the existing debug interfaces may be applied for transferring the power state information.

In another aspect of the invention, the method for estimating the power consumption of a program code that is executable on the electronic device may comprise an additional external power measurement. This may be advantageous if additional hardware is coupled to the electronic device. The energy consumption of this external circuitry may be determined by help of this additional power measurement. This is advantageous because the power consumption of the external circuitry cannot be estimated from debug data of the electronic device. According to this aspect of the invention, the interaction between the electronic device and the external circuitry may be determined with respect to power consumption.

According to another aspect of the invention, a debug unit for estimating a power consumption of an application that is executable on an electronic device having a plurality of modules is provided. The debug unit may be configured to receive data indicating a status of at least one routine of the application. Further, the debug unit may receive data indicating a status of at least one module of the electronic device. A power consumption of the at least one module may be estimated by the debug unit by allocating a predetermined power consumption value to the status of the respective module. The determined status of the routine may be assigned to the determined status of the at least one module and to the estimated power consumption of the module by the debug unit so as to provide an estimated power consumption of the application.

In another aspect of the invention, an electronic device comprising a plurality of modules and a debug module may be provided. The debug module may be configured to determine a status of at least one routine of an application that is executable on the electronic device. Further, the debug module may be configured to determine a status of at least one module. The electronic device may provide data that is indicative of the determined status of at least one routine and the status of the at least one module. The status data of the at least one module may be indicative of a power consumption of the at least one module.

Same or similar advantages that have been already mentioned with respect to the method according to aspects of the invention also apply to the debug unit and to the electronic device according to aspects of the invention.

### BRIEF DESCRIPTION OF DRAWINGS

Further objects of the invention will ensue from the following description of example embodiments of the invention with reference to the accompanying drawings, wherein

FIG. 1 shows a power statistic for an electronic device according to an embodiment of the invention,

FIG. 2 shows an electronic device according to another embodiment of the invention,

FIG. 3 shows a JTAG device state register of an electronic device according to an embodiment of the invention,

FIG. 4 shows an activity profile for an electronic device according to another embodiment of the invention,

FIG. 5 schematically illustrates a triggered activity measurement for an electronic device comprising a plurality of modules, according to aspects of the invention and

FIG. 6 shows a time-dependent power profile for an electronic device according to another embodiment of the invention.

### DETAILED DESCRIPTION OF AN EXAMPLE EMBODIMENT

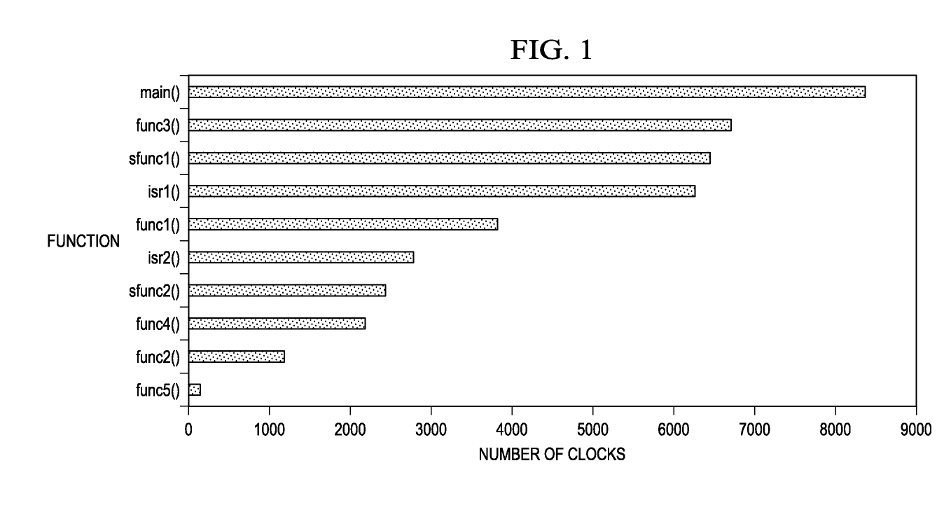

FIG. 1 shows a power statistic of an application. This power statistic illustrates a method for estimating a power consumption of an application, according to an embodiment of the invention. By way of an example only, the application comprises (inter alia) the routines: main, isr1, isr2, sfunc1, sfunc2 and fund to func5. These are denoted in the column “function” of FIG. 1. During execution of the application, each routine takes a certain number of system clock cycles. This value is denoted as a horizontal length of the bars that are assigned to a respective one of the routines. A corresponding number (#clocks) of system clock cycles is plot on the abscissa.

The power statistic shows which routine of the application is taking how many system clock cycles. As an average value the power consumption of a routine is proximately the same for all clock cycles. Accordingly, the power consumption may be assumed to be approximately directly proportional to the number of clock cycles (#clocks). In other words, the power consumption of a routine may be expressed in terms of clock cycles. A promising way for optimizing the energy consumption of an application and a routine, respectively, is to reduce its number of clock cycles. The developer should focus on routines taking a high number of clock cycles, because these routines are consuming the biggest fraction of the overall power. The software programmer will derive from FIG. 1 that he or she should focus on functions: main, func3, sfun1 and isr1.

The power statistic of FIG. 1 provides information on a distribution of the power consumption. There is no direct information about an absolute value of the power consumption of the respective routines. However, during the development of an application, it is more important to know the distribution of the power consumption and to know which routine is the most power consuming than to know to absolute value for the power consumption of each routine. Accordingly, the power statistic of FIG. 1 is valuable information for optimizing the application.

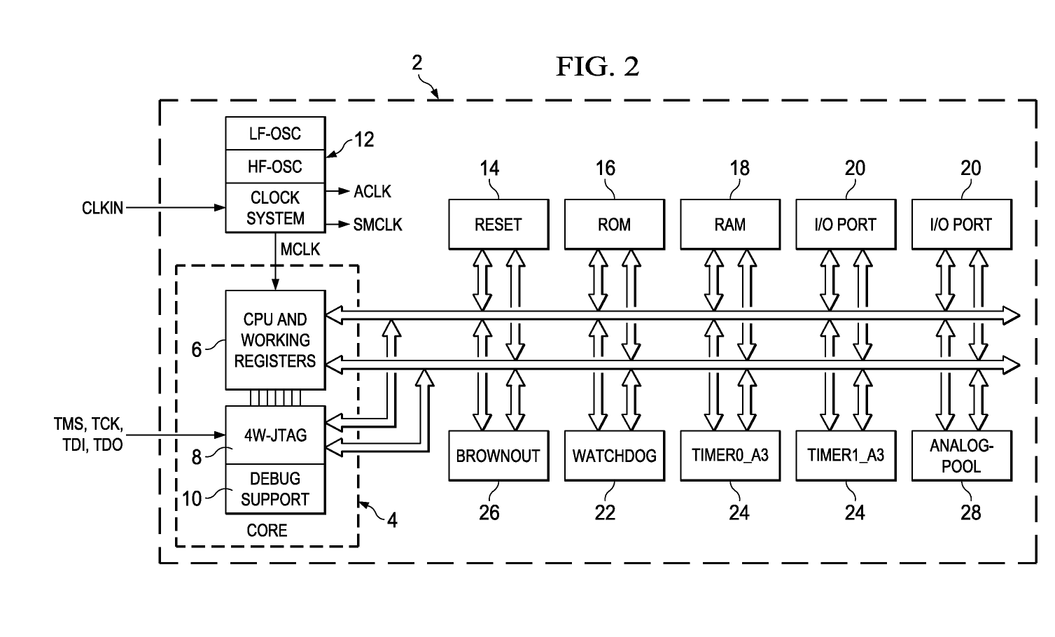

The power consumption of the respective routines may be determined via the debug system of the electronic device. Advantageously, no external power measurement is necessary. FIG. 2 shows a block diagram of an electronic device 2, e.g. a microcontroller, according to an embodiment of the invention. Within the context of this specification, each block of the electronic device 2 will be referred to as a module. A first module is the core 4, comprising the CPU 6 and assigned working registers. Further, the core 4 comprises a debug unit 8 that is preferably working according to the JTAG-standard, and debug support registers 10. The debug unit 8 communicates signals TMS, TCK, TDI and TDO, wherein TMS indicates the JTAG test mode selection, TCK is the JTAG test clock signal and TDI and TDO are signals indicating a JTAG test data input and output, respectively.

A further module of the electronic device 2 is the oscillator system 12 receiving a clock input signal CLKIN. The oscillator system 12 comprises a low-frequency oscillator LF-OSC and a high-frequency oscillator HF-OSC, which are further modules. An auxiliary clock signal ACLK, a sub-main clock signal SMCLK and a main clock signal MCLK are generated by the oscillator system 12. The main clock signal MCLK is coupled to the CPU and the sub-main clock signal SMCLK is coupled to peripheral modules. By way of an example only, the electronic device 2 comprises the following peripheral modules: a reset module 14, a ROM and RAM memory 16, 18, a module for digital I/O 20, a watchdog timer 22, a plurality of timer registers 24, an ultra low voltage brownout block 26 and an analog pool 28 providing a series of analog-to-digital functions. The analog pool 28 may comprise further modules, e.g. an ND converter.

A status of the electronic device 2 may be determined by reading the JTAG device state register of the debug unit 4. The JTAG register may provide read only information.

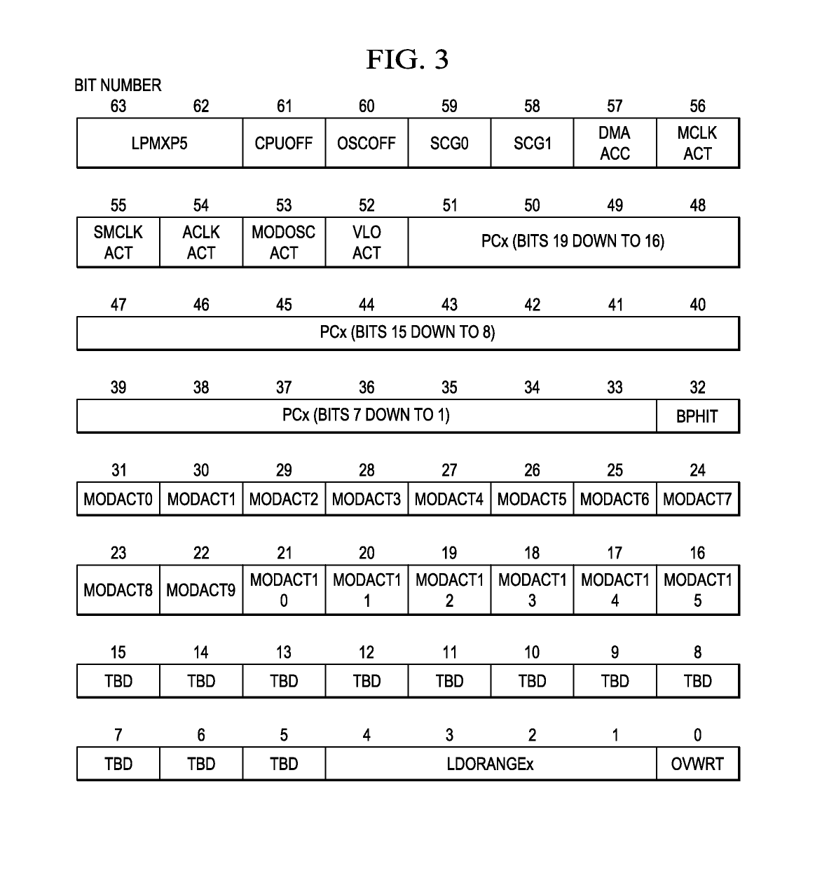

FIG. 3 is a 64-bit JTAG device state register of an electronic device, according to an embodiment of the invention. The first two bits (LPMXP5) indicate whether the JTAG register is locked or not and if the core is powered or not. The next bits CPUOFF, OSCOFF, OSGO, SCG1 reflect the power status of the core as defined in CPU status register. The bit DMAACC indicates if there is a DMA access or not. The following bits MCLK, SMCLK and ACLK reflect the activity of the main clock (MCLK), the sub-main clock (SMCLK) and the auxiliary clock (ACLK). The above-mentioned information allows determining the power mode of the electronic device. Typically, the activity of the CPU and the clocks of an electronic device 2 vary depending on the power mode of the electronic device. For instance, in an active mode, the CPU and all clocks are active. In a first low power mode, the CPU and the main clock (MCLK) are disabled. Further clocks, e.g. the sub-main clock (SMCLK), may be disabled in further low power modes. Accordingly, the relative power consumption of the electronic device 2 may be concluded from the clock status, for instance.

Further, the JTAG device state register may comprise the bits PC19 to PC1 (bits #51 to 33) which represent a program counter (PC) comprising information about a last instruction fetch by the CPU. A status of a routine of an application that is running on the electronic device may be determined based on these bits. The field BPHIT indicates if the program execution was stopped due to a breakpoint hit. The following bits MODACT0 to MODACT 15 (bits #31-16) reflect the activity of the respective modules of the electronic device 2. For instance, the activity of the digital I/O module 20 or the activity of the timer registers 24 may be indicated by respective fields. These fields may comprise further information about a power consumption of the respective modules. For instance, one or more bits may reflect a power mode of the analog pool 28. By way of an example only, these bits may indicate if one or more ND converters that are a part of the analog pool 28 are active or not. Accordingly this module may be in a high power mode if all A/D converters are active. It may be in a first low power mode if some A/D converters are active and may be in a second low power mode if the ND converters are disabled.

In summary, the debug system 8 of the electronic device 2 is capable of delivering information about: currently active functions, a call of functions, a return from finished functions, a call of interrupt service routines and a return from the interrupt. Information may be exchanged with an external debugging host via the JTAG debug port. This information will provide a basis for generation of the power profile as it is shown in FIG. 1. It is advantageous if the destination address of the respective function or routine is known by the debug host so it is able to follow the call stack of the respective function or routine.

According to an aspect of the invention, the developer may select a choice of routines for optimization. Accordingly only the selected routines are monitored while for the remaining routines no information in polled from or provided to the debug host. This may increase the power estimation process since less information is communicated to the debug host. A further option for code optimization with respect to its energy consumption is to reduce the code footprint in memory. This will lead to reduced power consumption due to reduced memory read access operations. However, in some cases, a reduction of the code footprint in the memory does worsen the number of clock cycles. For instance, using loops instead of recursive coding does reduce the code footprint but will increase the number of clock cycles for processing and memory readout. By help of the power statistic as it is shown in FIG. 1, the developer gets a general idea of the distribution of the energy consumption. He or she can specifically choose the routine that takes most of the processing time and can start optimizing this one first. This may be a fruitful approach because an optimization of this routine promises the most benefit.

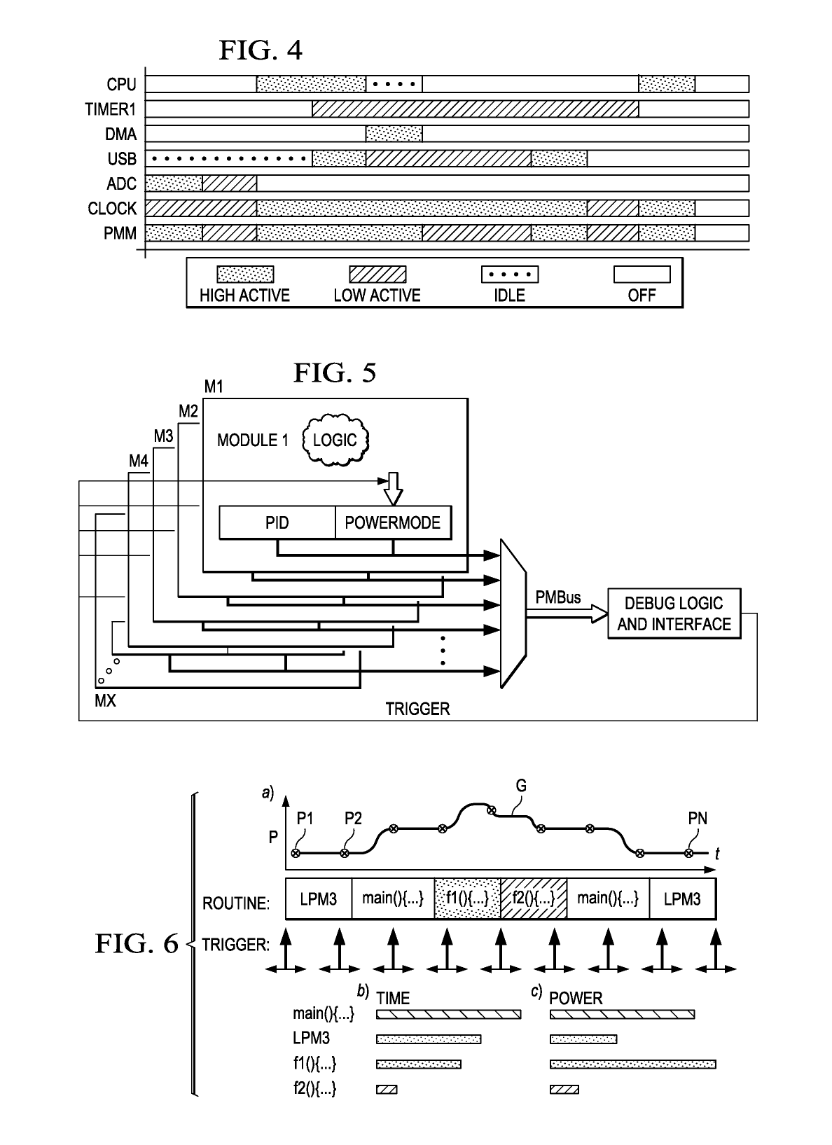

FIG. 4 is a time-dependent activity profile for an electronic device having a plurality of modules, according to an embodiment of the invention. By way of an example only, the following modules are monitored: CPU, a first timer (Timer1), a direct memory access (DMA), the activity of a USB port (USB), the activity of an analog-to-digital converter (ADC), the clock generator (CLOCK) and a power management module (PMM). The output graphics in FIG. 4 may be a colored bar diagram wherein the different colors indicate different states of operation for the respective modules. In the embodiment of FIG. 4, a dark area indicates a high activity, a hedged area indicates a low activity, a pointed area indicates that the respective module is idle and a light area indicates that the respective module is switched off. These states of the modules indicate their power consumption. A high activity indicates high power consumption, a low activity indicates lower power consumption and if the module is idle, its power consumption will be very small.

In FIG. 4, the most interesting blocks are CLOCK and PMM. This is because an auxiliary module like the PMM module may be needed by other modules of the electronic device. By aligning the respective blocks of the further modules in a time domain, it might be possible to reduce the operating time of the modules CLOCK and PMM. This will lead to a reduction of the power consumption of an electronic device that executes the respective application.

FIG. 5 illustrates the operation of a method for estimating the power consumption of an electronic device, according to another embodiment of the invention. For instance, the power consumption of a system on-chip (SOC) may be estimated. This SOC comprises a number of modules, namely M1, M2, M3, M4 to MX. In principle, the number X may be arbitrary. Upon reception of a trigger (Trigger) from the debug logic, each module M1 to MX of the SOC delivers an internal power state (Powermode) via a bus system (PMBus) to the external debug logic (Debug logic & Interface). The captured power states of the modules M1 to MX may be fetched in sequence. In addition to the power state of the modules M1 to MX, the program status, i.e. the status of the application may be fetched. This data incorporates the actual program counter and predetermined CPU status signals. In an aspect of the invention, only a subset of the modules of the electronic device, e.g. the modules that are known for high power consumption, may be incorporated in the method for estimating the power consumption. Accordingly, only these modules are triggered and deliver status information. Due to the reduced number of communicated parameters, the time needed for communicating the same may be reduced and the power debug process will be faster.

A result of the power debugging process is shown in FIG. 6. The inset a) illustrates a time-dependent power profile for execution of an application. The graph G may be a fit-function through the plurality of measurement points P1 to PN. On a time scale (t), the measurement points correspond to the occurrence of the trigger. In other words, upon each trigger, the actual power consumption (P) of the executed code is determined in the above-mentioned way. The sum of the power consumption for each one of the modules M1 to MX is illustrated as the P-value for each measurement point in the time-dependent power profile in FIG. 6a. The time dependent activity of the respective routines, namely LMP3, MAIN, F1 and F2 is illustrated by a bar graph that is synchronized on a time scale with the occurrence of the trigger signal.

In addition to the time-dependent power profile in inset a) of FIG. 6, the developer may be provided with the two insets b) and c), e.g. on a screen in a development environment. Inset b) illustrates the total processing time of the respective routines (i.e. MAIN, LMP3, F1 and F2). Inset c) illustrates the estimated power consumption of the respective routines. This information may be helpful for power-optimizing the program code. For instance, inset a) teaches that routine F1 causes the peak power and is the routine taking most of the power (see inset c)). Accordingly it might be a first approach to power-optimize this routine.

Although the invention has been described hereinabove with reference to specific embodiments, it is not limited to these embodiments and no doubt further alternatives will occur to the skilled person that lie within the scope of the invention as claimed.

1. A method of estimating a power consumption of an application that is executable on an electronic device having a plurality of modules, the method comprising the steps of:
a) determining a status of at least one routine of the application,
b) determining a status of at least one module of the electronic device,
c) estimating a power consumption of the at least one module by allocating a predetermined power consumption value to the detected status of the respective module,
d) assigning the determined status of the routine to the determined status of the at least one module and to the estimated power consumption of the module so as to provide an estimated power consumption of the application.

2. The method according to claim 1, further comprising the step of generating a power statistic of the application by estimating a power consumption of at least two routines and by setting the two estimated power consumption values in relation to each other.

3. The method according to claim 2, wherein the step of estimating a power consumption is performed by determining a number of clock cycles that are taken by the at least one routine.

4. The method according to one of the preceding claims, further comprising the step of generating a system activity profile by determining a status of at least two modules of the electronic device, wherein the determined status is indicative of a power consumption of the respective module, and outputting the determined status in a time depended plot.

5. The method according to claim 4, further comprising the step of generating a time dependent power profile of the application by assigning the determined status of the application to the determined status of the at least one module and to the corresponding estimated power consumption for a plurality of points in time and outputting the power profile in a time depended plot.

6. The method according to claim 4, wherein the determination of the status of the at least one routine of the application and the determination of the status of the at least one module of the electronic device is performed upon reception of a trigger.

7. A debug unit for estimating a power consumption of an application that is executable on an electronic device having a plurality of modules, wherein the debug unit is configured to:
a) receive data indicating a status of at least one routine of the application,
b) receive data indicating a status of at least one module of the electronic device,
c) estimate a power consumption of the at least one module by allocating a predetermined power consumption value to the status of the respective module,
d) assign the determined status of the routine to the determined status of the at least one module and to the estimated power consumption of the module so as to provide an estimated power consumption of the application.

8. An electronic device comprising a plurality of modules and a debug module, wherein the debug module is configured to:
a) determine a status of at least one routine of an application that is executable on the electronic device,
b) determine a status of at least one module,
c) provide data that is indicative of the determined status of at least one routine and the status of the at least one module, wherein the status data of the at least one module is indicative of a power consumption of the at least one module.
